(19) United States
(12) Patent Application Publication
(10) Pub. No.: US 2013/0212162 A1
(43) Pub. Date: Aug. 15, 2013

(54) CONTROL STRUCTURE FOR CONTENT DELIVERY AND MANAGEMENT

(71) Applicant: CiiNOW, Inc., (US)

(72) Inventor: Gurudas SOMADDER, San Jose, CA (US)

(73) Assignee: CIINOW, INC., Mountain View, CA (US)

(21) Appl. No.: 13/739,498

(22) Filed: Jan. 11, 2013

Related U.S. Application Data
(60) Provisional application No. 61/586,084, filed on Jan. 12, 2012.

(51) Int. Cl. H04L 29/06

(52) U.S. Cl. CPC H04L 67/42
USPC 709/203

(57) ABSTRACT

A method for providing content delivery and management to a client device that includes mapping the client device to a corresponding controller, presenting available content to the client device, determining data centers available to service the client device, and initializing a data center to service content requested by the client.

### CROSS-REFERENCE TO RELATED APPLICATIONS

This present application claims the benefit of U.S. Provisional Application No. 61/586,084, filed Jan. 12, 2012, which is hereby incorporated by reference in its entirety.

### FIELD OF THE INVENTION

This invention relates to the field of content delivery and management.

### BACKGROUND

Content delivery involves providing content (e.g., audio, video) from a remote location to a client device (e.g., mobile phone, computer). Content delivery allows a user of the client device to enjoy access to content independent of user location. However, current approaches for content delivery and content management suffer from several inefficiencies. This is especially true in the field of remote gaming, where a user of a client device interacts with content in the form of a game program that is running and being processed at a remote location.

It is often desirable for a user of a client device to receive content tailored to his device capabilities and preferences. When content is made available to a user of a client device without accounting for device capabilities, the content may suffer in quality or be completely incompatible with the client device. For example, a client device with low resolution support may attempt to interact with a video game that is graphics intensive, resulting in inefficient and low quality gameplay due to insufficient device capabilities.

Additionally, remote processing and delivery of content may be provided by several different data centers distributed across the world. The quality of content received by the user of the client device may be dependent on the device's proximity to the data centers as well each data center's processing capability (e.g., amount of hardware resources). Also, the price paid by the user for accessing content may change depending on the device's proximity to the data centers. For example, a user of a mobile telephone device traveling in the United Kingdom may have a service provider with associated data centers based in the United States. Accessing content using the data center located in the United States may cause the user to experience degradation in content quality as well as an increase in access fees (e.g., roaming charges). By instead using a data center that is closer in proximity to the client device, such as for example, a data center associated with a service provider in the United Kingdom, the user of the client device may experience greater content quality and lesser access fees.

Likewise, a user having several different client devices may want to access content from different client devices while maintaining the context of that content. For example, a user may be playing a video game on his home desktop, and decide that he would like to finish playing the video game on his mobile telephone device because he needs to get somewhere. Rather than having to restart the video game from the beginning, the user may desire to continue playing the video game on his mobile telephone device from the same checkpoint (e.g., context) as he was playing on the home desktop.

Therefore there is a need for an improved control structure for content delivery and management which addresses these and other problems with prior implementations.

### BRIEF DESCRIPTION OF THE DRAWINGS

In order that the present invention is better understood a control structure for content delivery and content management in accordance with the invention will now be described, by way of example only, with reference to the accompanying drawings in which like reference numerals are used to denote like parts, and in which:

FIG. 1 illustrates a block diagram of a content delivery and management system in accordance with some embodiments.

FIG. 2 illustrates a block diagram of an example data center architecture in accordance with some embodiments.

FIG. 3A is a flow diagram illustrating a method for content delivery and management from the perspective of the client for the content delivery and management system described above in FIG. 1.

FIG. 3B is a flow diagram illustrating a method for content delivery and management from the perspective of the control structure for the content delivery and management system described above in FIG. 1.

FIG. 3C is a flow diagram illustrating a method for content delivery and management from the perspective of the data center for the content delivery and management system described above in FIG. 1.

FIG. 4A is a flow diagram illustrating a method for implementing the follow-me feature from the perspective of the user for the content delivery and management system described above in FIG. 1.

FIG. 4B is a flow diagram illustrating a method for implementing the follow-me feature from the perspective of the control structure for the content delivery and management system described above in FIG. 1.

FIG. 4C is a flow diagram illustrating a method for implementing the follow-me feature from the perspective of the data center for the content delivery and management system described above in FIG. 1.

FIG. 5A is a flow diagram illustrating a method for implementing content context save and restore from the perspective of the user for the content delivery and management system described above in FIG. 1.

FIG. 5B is a flow diagram illustrating a method for implementing content context save and restore from the perspective of the control structure for the content delivery and management system described above in FIG. 1.

FIG. 5C is a flow diagram illustrating a method for implementing content context save and restore from the perspective of the data center for the content delivery and management system described above in FIG. 1.

### DETAILED DESCRIPTION

Various embodiments are described hereinafter with reference to the figures. It should be noted that the figures are not necessarily drawn to scale. It should also be noted that the figures are only intended to facilitate the description of the embodiments and are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiments” or “in other embodiments” in various places throughout this specification are not necessarily referring to the same embodiment or embodiments.

For the purposes of illustration only, the following description is made with examples that reference content embodied specifically as video game content. However, the invention is applicable to any type of content, such as video content and audio content. As such, the invention is not limited to video game content unless claimed as such.

According to some embodiments, a control structure for content delivery management is provided in which the control structure is configured to provide content management for client devices including content context management for client devices, and content context save and restore for client devices. Content management involves determining content availability based on client device capabilities and user information as well as determining data centers for servicing content for client devices. Content context management involves allowing a client device to pause and restart content and also allowing a user to switch client devices while maintaining content context. Content context save and restore involves saving content for a user of a client device and restoring content to a user of a client device.

In this way, embodiments of the invention provide efficient content delivery and control for client devices by tailoring content for client devices, managing data center assignment for client devices, providing content context management for users of client devices, and providing content context save and restore for users of client devices.

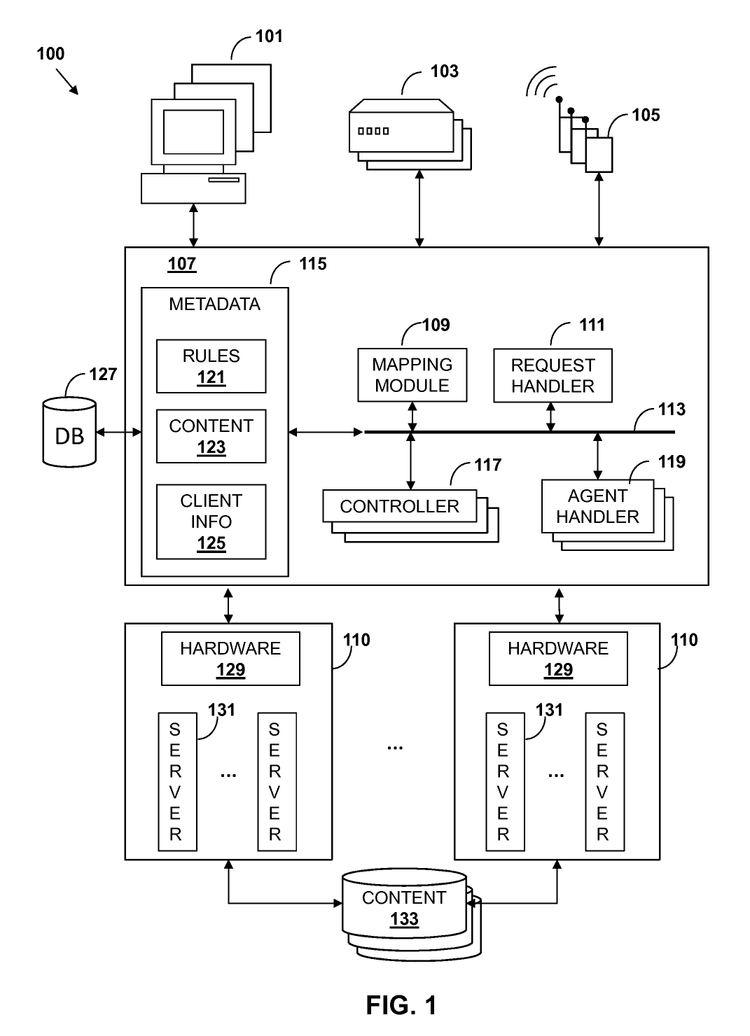

FIG. 1 illustrates a content delivery and management system 100 in accordance with some embodiments. The content delivery and management system 100 provides content management, content context management, and content context save and restore for a plurality of client devices 101, 103, 105 using a control structure 107 and a plurality of data centers 110. The functionality of these components will be described in detail below.

A plurality of client devices 101, 103, 105 may communicate with the control structure 107 to facilitate content delivery and content management. The client devices may include a computer (both desktop and laptop) 101, a set-top box 103, mobile telephone devices 105, or any other client device capable of receiving content and communicating over a network. Each client device may communicate with the control structure 107 over different networks using a different communication protocol. For example, the computer 101 may communicate with the control structure 107 over the internet using hypertext transfer protocol (HTTP). Alternatively, the mobile telephone devices 105 may communicate with the control structure 107 over a cellular network using a different protocol (e.g., global system for mobile communications (GSM) or code division multiple access (CDMA)).

The control structure 107 performs content management, content context management, and content context save and restore for the client devices 101, 103, 105 and facilitates content delivery to the client devices by the data centers 110. The control structure 107 may contain a mapping module 109, a request handler 111, a messaging bus 113, metadata 115, a hierarchy of controllers 117, and one or more agent handlers 119. The mapping module 109, request handler 111, metadata 115, controllers 117, and agent handlers 119 may each be functionally connected to the messaging bus 113 and communicate information to each other over the messaging bus.

The mapping module 109 is configured to map the client device 101, 103, 105 to a corresponding controller 117. Mapping may be based on a set of rules contained in the metadata 115, which will be discussed in further detail below.

A request handler 111 may be configured to translate information received from the client device 101, 103, 105 into an appropriate form for processing by the controller 117. Because each client device 101, 103, 105 may communicate with the control structure 107 using a different protocol, a request handler 111 may be necessary to interpret the client communication and translate it into an appropriate form for processing by a controller 117.

The metadata 115 may also be functionally connected to the messaging bus 113, such that information contained within the metadata 115 may be accessed by a controller 117, an agent handler 119, a mapping module 109, or request handler 111. The metadata 115 may contain rules metadata 121, content metadata 123, and client information metadata 125. Rules metadata 121 may include rules for how content may be accessed, how data centers may be assigned, and how client devices may be mapped. Content metadata 123 may include a library of content, the location of content, and resource requirements for each piece of content. User information metadata 125 may include a history of a user's content accesses, user preferences, and information related to a user's saved and paused content (e.g., content context). Metadata 115 may be stored within the control structure or may also be stored in an external database 127 that may be accessed by the control structure 107.

The hierarchy of controllers 117 is configured such that each controller 117 is associated with a plurality of data centers 110. For example, a controller 117 may be associated with a set of data centers within a geographic region. The controller is responsible for facilitating content management, content context management, and content context save and restore for a particular client device 101, 103, 105. Functionality of the controller 117 will be discussed in greater detail below.

A controller 117 may be associated with one or more agent handlers 119 that are configured to manage (e.g., provide fault tolerance and load balancing) the one or more data centers 110 associated with the controller 117. For example, an agent handler may determine which data center 110 associated with the controller 117 has adequate system resources to service the client device 101, 103, 105. The agent handler 119 may communicate with its associated data centers 110 to obtain information regarding a data center's 110 workload and available resources and may also direct a data center 110 to initialize content for delivery.

Each data center 110 may be configured to provide content processing and content delivery to client devices 101, 103, 105. Each data center 110 may include hardware resources (e.g., CPU, GPU, memory, etc.) 129, and a plurality of servers 131 sharing the hardware resources and configured to retrieve content, process content, and deliver content to client devices 101, 103, 105. The content may be stored in one or more databases 133 remote to the data center 110, such that content may be retrieved and processed simultaneously by more than one data center 110.

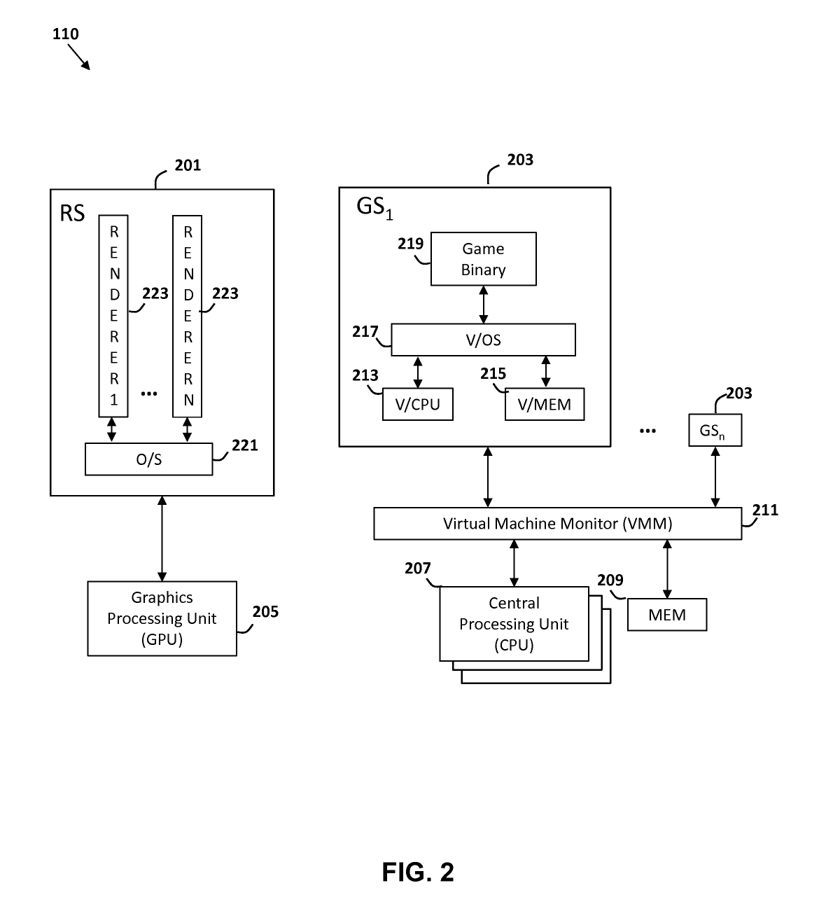

The control structure 107 is configured to support any type of data center architecture including any data center architecture described in provisional application No. 61/585,851 entitled “Data Center Architecture for Remote Graphics Rendering”, referenced by attorney docket no. CII-005, and filed on Jan. 12, 2012, which is herein incorporated by reference in its entirety. An example data center 110 is illustrated in FIG. 2, and will be referred to throughout the description. It is important to note that while only a particular data center architecture embodiment will be described, one ordinarily skilled in the art will understand that the foregoing description may be modified and extended to support any data center architecture. The following description of the data center 110 is made with reference to content embodied specifically as video game content. However, the invention is applicable to any type of content, such as video content or audio content.

The data center 110 comprises underlying hardware including a graphics processing unit (GPU) 205, a central processing unit (CPU) 207, and a memory 209. The GPU 205 and CPU 207 may be housed in separate physical machines, and the CPU 207 may include multiple processing cores, with each processing core capable of executing multiple threads. A physical rendering server 201 is functionally connected to the GPU 205 and a plurality of virtual machine game servers 203 are functionally connected to a virtual machine monitor 211, which is functionally connected to the CPU 207 and memory 209. Each virtual machine game server 203 is a software abstraction of its underlying hardware (e.g., CPU and memory) and shares the underlying hardware resources with other virtual machine game servers 203. The rendering server 201 is configured to perform all GPU processing and the virtual machine game servers 203 are configured to perform all CPU processing.

For purposes of example, each virtual machine game server 203 includes a virtual processor 213, a virtual memory 215, a virtual operating system 217, and a game binary 219. Each virtual machine game server 203 corresponds to a particular client that is interacting with the data center 110. The physical rendering server 201 includes an operating system 221 and one or more renderers 223. Each renderer 223 corresponds to a particular virtual machine game server 203 as well as the client device corresponding to that particular virtual machine game server.

The virtual machine game server 203 and corresponding renderer 223 of the rendering server 201 may interact with each other to process video game instructions and render video game images for delivery to the client device. A virtual machine game server 203 may initialize a game binary 219 (e.g., game program) corresponding to the game selected by its corresponding client device. The game binary 219 may run under the control of the virtual operating system 217 and may generate a sequence of game binary instructions corresponding to the current state of the game. The virtual machine game server 203 is configured to receive input from the client device to facilitate interaction between the client and the game binary 219. The virtual machine game server 203 may receive input from its corresponding client device and the game binary 219 may generate a sequence of game binary instructions in accordance with the input. The game binary instructions may then be executed by the virtual processor 213 to generate a set of graphics command data to be transmitted to a corresponding renderer 223. The renderer 223 may then render one or more video game images from the set of graphics command data received from the virtual machine game server 203. The video game images may then be transmitted by the renderer 223 to its associated client.

In order to facilitate communication between the virtual machine game server 203, the renderer 223, and the client device, the virtual machine game server 203 may be provided a particular address associated with its corresponding renderer 223 by the control structure and may communicate with the corresponding renderer 223 using that address. Likewise, the renderer 223 may be provided a particular address associated with the client device by the control structure and may communicate with the client device using that address. Further details regarding the utilization of the data center will be discussed in further detail below.

It is important to note that virtual machines are not necessary to provide this functionality—it is just one example of a data center architecture. Other data center architectures could include running multiple games simultaneously on the same physical server which might be running both the rendering and game servers in a combined mode.

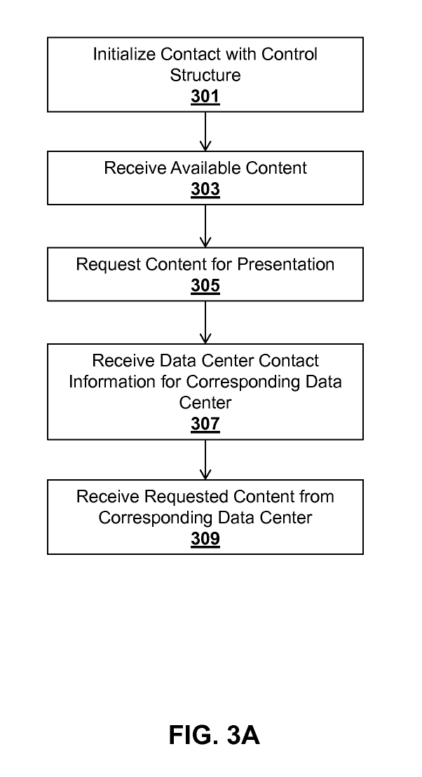

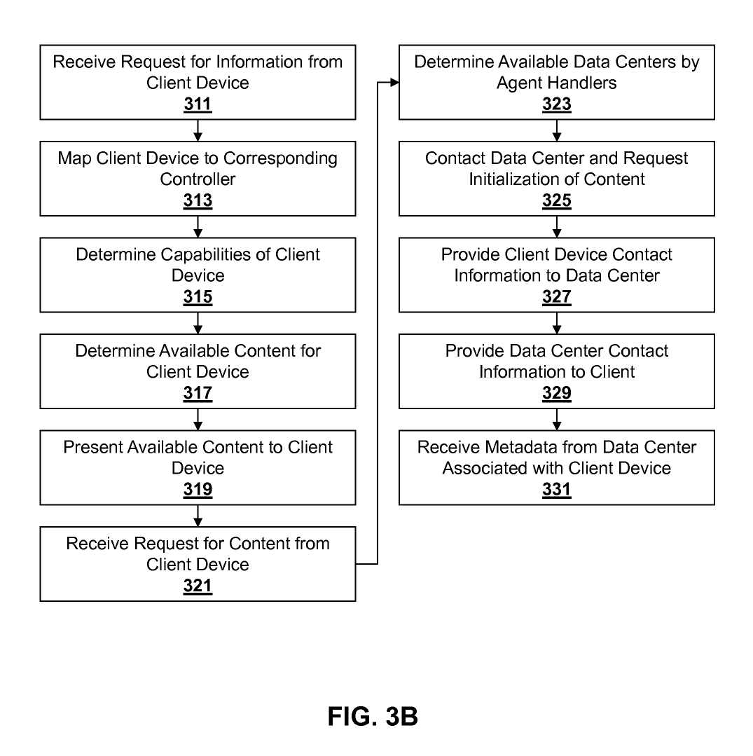

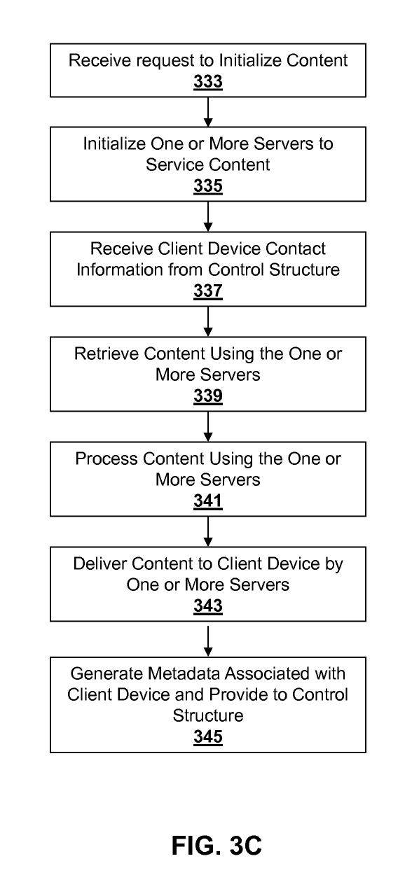

FIG. 3A is a flow diagram illustrating a method for content delivery and management from the perspective of the client for the content delivery and management system described above in FIG. 1.

A user of a client device first initializes contact with the control structure as described in step 301. Initializing contact with the control structure involves contacting the control structure with a request for information. Such a request will include an address (e.g. IP address) associated with the client device and may also contain other information associated with the client device. For example, the request may indicate the client device type, client device operating system, bandwidth allocated for client device, or I/O components associated with client device. Initializing contact may further include providing log-in information for the user of the client device to identify the user and facilitate management of content specific to that user.

The client device then receives available content based on his request for information as described in step 303. The content available to the client device is determined by the control structure, and may vary based on the information associated with the client device and information associated with a particular user of the client device (e.g., user preferences, stored content associated with the user). For example, a client device running the Windows operating system may only receive available content in the form of video games that are capable of running on the Windows platform. Likewise, a particular user of a client device may receive additional available content such as previously saved games and unlocked features.

The user of the client device may then request content for presentation as described at step 305. Requesting content for presentation will cause the control structure to initialize an appropriate data center architecture for servicing the client device, which will be discussed in detail below. The client device will then receive data center contact information for its corresponding data center as described in step 307. Using the data center architecture described in FIG. 2 as an example, the client device may receive an address associated with its corresponding virtual machine game server in order to provide input to the corresponding virtual machine game server for interacting with the game binary.

At this point, the client device may communicate directly with its corresponding data center without having to go through the control structure. The client device then receives content from its corresponding data center as described in step 309.

FIG. 3B is a flow diagram illustrating a method for content delivery and management from the perspective of the control structure for the content delivery and management system described above in FIG. 1.

The control structure initially receives a request for information from a client device as described at step 311. The request for information allows the control structure to initialize contact with the client device. The request for information includes an address (e.g. IP address) associated with the client device as well as other information associated with the client device.

The mapping module of the control structure will then map the client device to a corresponding controller as described at step 313. The mapping module may apply a set of metadata rules to the address associated with the client device to determine a corresponding controller. For example, the rules may direct the mapping module to assign a client device to a corresponding controller based on physical proximity of the client device to the data centers associated with the controller. In other embodiments, the rules may direct the mapping module to bypass a controller corresponding to data centers associated with the service provider of the client device for a controller corresponding to data centers associated with an associate service provider. For example, where a mobile telephone device with a US service provider and associated US data centers is roaming outside of its coverage area, it may be more beneficial to assign the mobile telephone device to a controller corresponding to a local service provider and its associated local data centers to avoid roaming charges

The controller will then determine the capabilities of the client device based on information associated with the client device contained in the request for information as described in step 315. Such capabilities may include the client device type, client device operating system, bandwidth allocated for client device, or I/O components associated with client device.

The controller may then determine available content for the client device as described in step 317. Determination of available content for the client device is based on client device capabilities and metadata. Content metadata 123 that includes a library of content, the location of content, and resource requirements for each piece of content may be compared to the client device capabilities in determining available content. Rules metadata 121 that includes rules for how content may be accessed may also be used in determining available content. Additionally, where a user of the client device provides login information, user information metadata 125 that includes a history of a user's content accesses, user preferences, and information related to a user's saved and paused content may be used in determining available content.

The available content may then be presented to the user by the control structure as described in step 319. A request for content may then be received by the control structure from the client device as described at step 321. Based on the request for content, the one or more agent handlers associated with the controller may determine an available data center for servicing the client device as described at step 323. Determination of available data centers may be based on metadata. For example, content metadata may indicate that the content requested by the client device is graphics intensive and requires a data center with several GPUs. In another example, user information metadata may indicate that the content requested by the client device was paused by the user when utilizing a different client device, and a data center has already been assigned to process and deliver the paused content. Because the agent handlers communicate with data centers to obtain information regarding a data center's workload and available resources, the agent handler may adequately select a data center for servicing the client device.

After determining available data centers for servicing a client device, the agent handler may contact the available data center and request initialization of content as described at step 325. Using the data center architecture described in FIG. 2 as an example, the agent handler may request the data center to initialize a renderer of the rendering server and a virtual machine game server to service the client device by providing CPU and GPU processing for a video game requested by the client device. The agent handler may also provide content location information to the virtual machine game server such that the virtual machine game server may retrieve the game binary from that location and initialize the game binary. The agent handler may further provide virtual machine game server contact information to the renderer and renderer contact information to the virtual machine game server such they can communicate to provide video game processing for the client device.

The control structure may then provide client device contact information to the data center as described at step 327. Such contact information may be an IP address associated with the client device that allows the data center to communicate directly with the client device. Using the data center architecture described in FIG. 2 as an example, the address of the client device may be provided to the renderer of the rendering server associated with the client device, such that the rendering server may directly deliver rendered video game images to the client device.

The control structure may simultaneously provide data center contact information to the client device as described at step 329. Using the data center architecture described in FIG. 2 as an example, the address of the virtual machine game server may be provided to the client device, such that the client device may transmit input to the virtual machine game server to facilitate interaction with the game binary. In a different example, if multiple game instances were running on the same datacenter machine, then the contact information may include a port offset to allow the client to connect to the correct game instance.

At this point, the client device communicates directly with its corresponding data center without having to go through the control structure, but the control structure continues to receive metadata from the data center associated with the client as described in step 331. Such metadata may be used to provide further content management and delivery, which will be described in further detail below.

FIG. 3C is a flow diagram illustrating a method for content delivery and management from the perspective of the data center for the content delivery and management system described above in FIG. 1.

The data center first receives a request to initialize content from the control structure as described at 333. The request to initialize content may come from an agent handler located within the control structure. The request may include information regarding the resources needed to provide content processing for a particular piece of content as well as the location of the content. Using the data center architecture described in FIG. 2 as an example, the request may indicate that the data center requires a GPU and a multi-threaded CPU to be initialized for processing content.

The data center may then initialize one or more servers to service the content in response to the control structure's request as described at step 335. Using the data center architecture described in FIG. 2 as an example, the data center may initialize a virtual machine server and a corresponding renderer of the rendering server for processing the content. In initializing the one or more servers, the data center may receive contact information for the servers from the control structure such that the servers may communicate amongst each other. Using the data center architecture described in FIG. 2 as an example, the renderer may receive contact information for its corresponding virtual machine game server from the control structure and the virtual machine game server may receive contact information for its corresponding renderer from the control structure. In another example, the data center may simply pick a physical machine that is already servicing other content, and initialize a new instance of the requested game on that machine.

Once the data center has initialized one or more servers, the data center receives client device contact information from the control structure as described at step 337. The client device contact information allows the data center to communicate directly with the client device without having to go through the control structure. Using the data center architecture described in FIG. 2 as an example, the renderer associated with the client device may receive an address of the client device, such that the renderer may directly transmit rendered video game images to the client device.

The one or more servers initialized for the client device may then retrieve the content as described in step 339. The one or more servers may retrieve the content using the content location provided by the control structure. Using the data center architecture described in FIG. 2 as an example, the virtual machine game server may retrieve the game binary from content stored in the one or more databases remote to the data center.

The data center may then process the content using the one or more servers associated with the client device as described in step 341. Processing the content may involve processing in accordance with client device input being provided to the one or more servers. Using the data center architecture described in FIG. 2 as an example, the virtual machine game server may generate a sequence of game binary instructions in accordance with input received from the client device and execute the game binary instructions to generate a set of graphics command data. The set of graphics command data may be transmitted to a corresponding renderer of the rendering server where they are used to render one or more video game images.

The content may then be delivered by the one or more servers to the client device as described in step 343. Using the data center architecture described in FIG. 2 as an example, the renderer may transmit the rendered one or more video game images to the client device.

The data center may simultaneously generate metadata associated with the client and provide it to the control structure as described in step 345. Such metadata may include context information associated with the content being delivered to the client device. The metadata may be used to provide further content management and delivery, which will be described in further detail below

The content delivery and management system 100 of FIG. 1 may additionally provide content context management. Content context management allows a client device to play content, pause content, and implement a follow-me feature which will be discussed in further detail below. Once a client device has been assigned to a corresponding data center and associated servers using the methods described above in FIGS. 3A, 3B, and 3C, the client device may continue to play content by receiving processed content from the servers. The client may directly interact with the content by providing input to its corresponding data center and associated servers, such as for example, where the content is a video game. When the client device decides to pause content, the data center will simply freeze processing of the content and hold further delivery of content to the client device until the client device indicates that it is ready to continue playing content. In some embodiments, the data center may implement a time threshold for keeping the one or more servers associated with the client device active, such that the one or more servers associated with the client device may automatically terminate after the time threshold has been exceeded. The data center may also provide user information metadata to the control structure indicating that content associated with a user of the client device has been paused.

The content delivery and management system 100 of FIG. 1 also allows a client device to implement a follow-me feature, whereby content that is paused by a user of a client device may be restarted from its paused position by the same user using a different client device. For example, a user of a desktop may pause a video game that he is playing and restart the video game from the paused position using a different client device such as a mobile phone or set-top box.

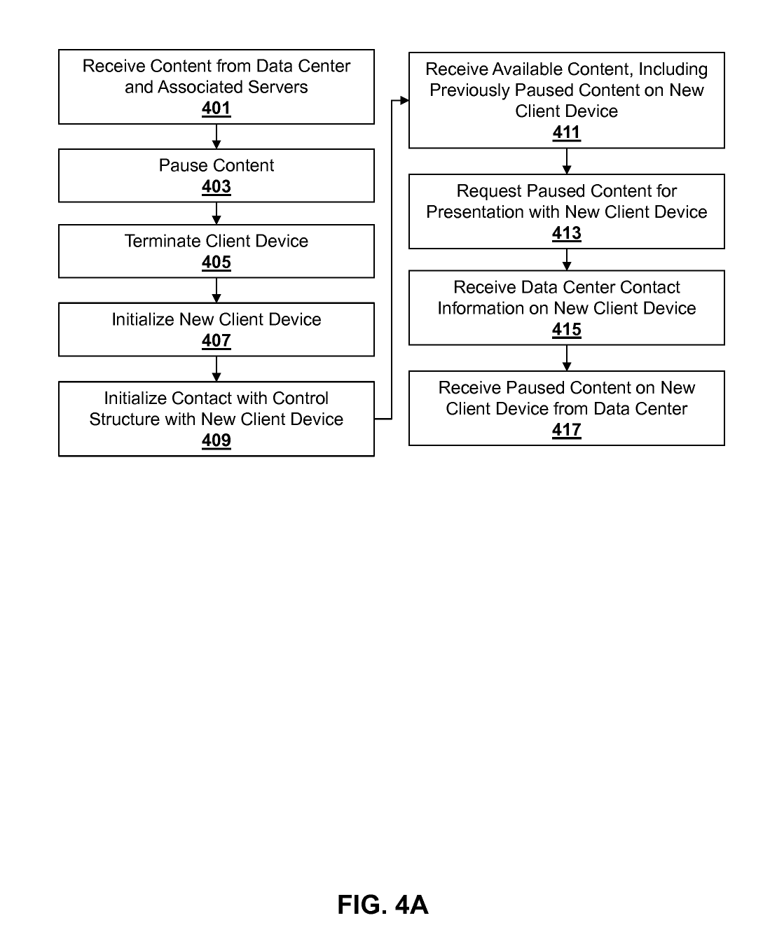

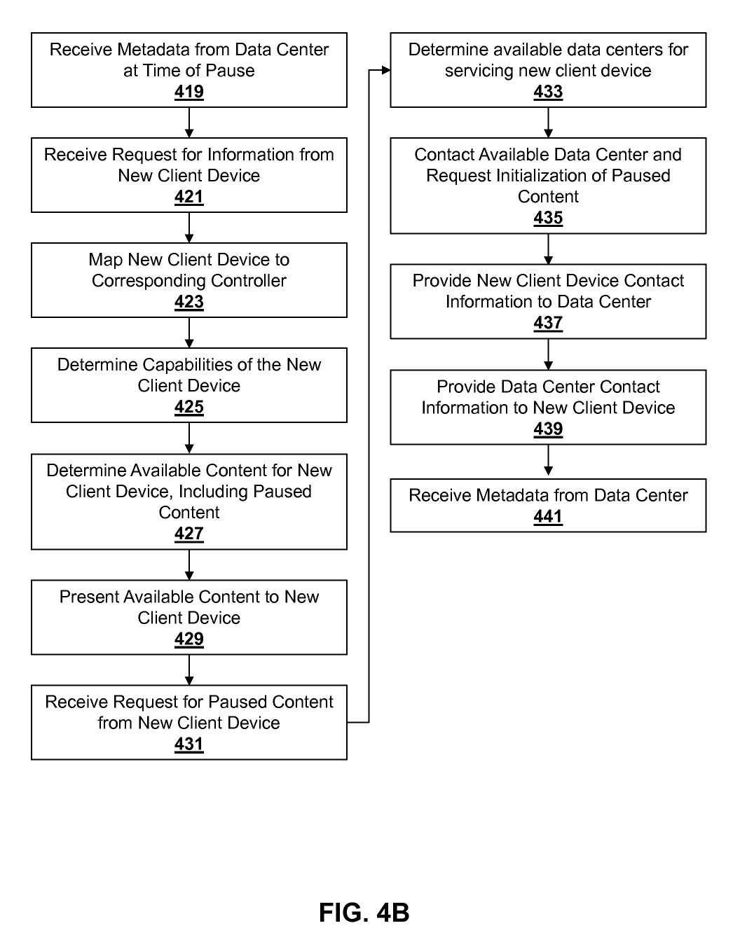

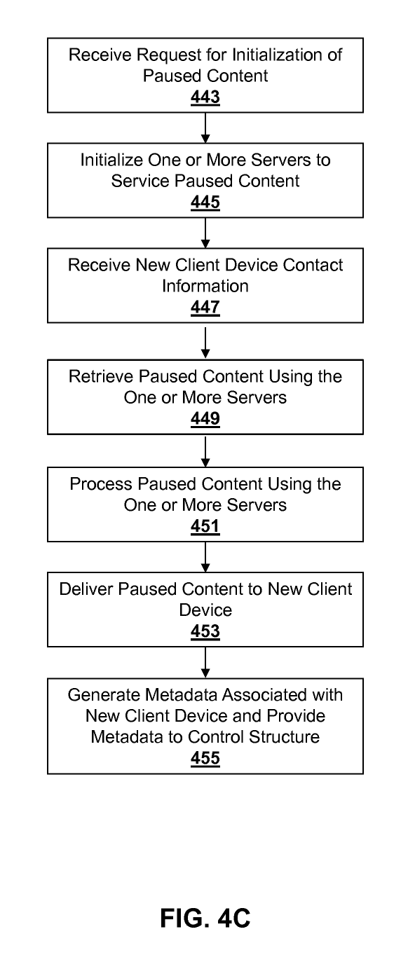

FIGS. 4A, 4B, and 4C are flow diagrams illustrating a method for implementing the follow-me feature from the perspective of the user, control structure, and data center respectively for the content delivery and management system described above in FIG. 1.

FIG. 4A is a flow diagram illustrating a method for implementing the follow-me feature from the perspective of the user for the content delivery and management system described above in FIG. 1. Initially, the user of a client device may receive content from its corresponding data center and associated servers as described at step 401 and also described above.

The user of the client device may decide to pause the content as described at step 403. Pausing the content may involve sending an indication to the corresponding data center using an input device associated with the client device. Once the user of the client device pauses the content, the data center may transmit metadata to the control structure that identifies the user of the client device, that identifies the associated servers processing the content, and that provides information about the content context (e.g., content information at time of pause).

The user may then terminate the client device as described at 405. Terminating the client device may comprise shutting down the client device or suspending the client device. Even though the user has terminated the client device, the corresponding data center and associated servers may remain active for a time threshold.

The user may next initialize a new client device as described at step 407. The new client device need not be the same as the former client device. For example, the user may shut down his desktop and turn on his cellular phone.

The new client device may then initialize contact with the control structure as described in step 409. The user of the new client device may be required to provide login information to the control structure upon initialization in order for the content delivery and management system to implement the follow-me feature.

After the new client device has initialized contact with the control structure, the new client device may receive available content from the control structure, including previously paused content as described at 411. The control structure may become aware of the availability of previously paused content using the metadata received from the data center and associated servers at the time of pause.

The new client device may then request for presentation of the paused content as described at 413. In some embodiments, requesting paused content for presentation will cause the control structure to use the metadata to locate the data center and associated servers previously assigned to the former client device and reassign the data center and associated servers to the new client device. Further details will be described below.

The new client device may then receive data center contact information as described at 415. At this point, the new client device may communicate directly with its corresponding data center without going through the control structure. The new client device then receives paused content from its corresponding data center as described in step 417.

FIG. 4B is a flow diagram illustrating a method for implementing the follow-me feature from the perspective of the control structure for the content delivery and management system described above in FIG. 1. When the client device pauses its content (e.g., either by closing the game, or explicitly requesting a pause or switching to another application), the control structure receives metadata from the client device's corresponding data center as described at 419. The metadata may identify the user of the client device, identify the associated servers processing the content, and provide information about the content context (e.g., content information at time of pause). The control structure may store the metadata received from the data center until at least the time threshold has been met.

The control structure then receives a request for information from the new client device as described at step 421. The control structure may receive login information from the user of the new client device along with the request for information.

The mapping module of the control structure will then map the new client device to a corresponding controller as described at step 423. As described above, the mapping module may apply a set of metadata rules to the address associated with the new client device to determine a corresponding controller. For example, the rules may direct the mapping module to assign the new client device to the controller associated with the former client device because they have a common user.

The controller will then determine the capabilities of the new client device based on information associated with the new client device contained in the request for information as described in step 425. Such capabilities may include the new client device type, the new client device operating system, bandwidth allocated for the new client device, or I/O components associated with the new client device. The capabilities of the new client will be used by the control structure to direct a data center to process paused content and deliver paused content in a manner consistent with the capabilities of the new client device, which will be described in more detail below.

The controller may then determine available content (including paused content) for the new client device as described in step 427. Determination of available content may be based on new client capabilities and metadata. Available content includes paused content which may be determined by the controller by using user information metadata provided to the control structure at the time of pause.

The available content, including paused content may then be presented to the user of the new client device by the control structure as described in step 429. A request for paused content may then be received by the control structure from the new client device as described at step 431. The one or more agent handlers associated with the controller may then determine an available data center for servicing the new client device as described at step 433. Servicing the new client device includes processing and delivery of requested paused content to the new client device. Determination of available data centers may be based on the client device capabilities and metadata. For example, metadata may identify the active data center corresponding to the terminated client device and its associated servers for processing and delivery of the paused content. Alternatively, the metadata may identify a different data center and associated servers that are more suitable for processing and delivery of paused content in accordance with the capabilities of the new client device. For example, a new client device may support a more limited resolution in comparison to the former client device and as such a data center with a lesser amount of GPU resources may be chosen to service the new client device.

After determining available data centers for servicing a client device, the agent handler may contact the available data center and request initialization of paused content as described at step 435. In some embodiments, the agent handler may simply contact the data center and associated servers previously servicing the terminated client device. In other embodiments, the agent handler may contact a different data center from the one previously servicing the former client device.

The control structure may then provide new client device contact information to the data center as described at step 437. Such contact information may be an IP address associated with the new client device that allows the data center to communicate directly with the new client device.

The control structure may simultaneously provide data center contact information to the new client device as described at step 439. At this point, the new client device communicates directly with its corresponding data center without having to go through the control structure, but the control structure continues to receive metadata from the data center associated with the client as described in step 441.

FIG. 4C is a flow diagram illustrating a method for implementing the follow-me feature from the perspective of the data center for the content delivery and management system described above in FIG. 1.

The data center first receives a request to initialize paused content from an agent handler located within the control structure as described at 443. In some embodiments, the request may be received by the data center that was servicing the former client device. In other embodiments, the request may be received by a data center different from the one servicing the former client device. Where the data center is different from the one servicing the former client device, the request may include information regarding the resources needed to provide content processing for the paused content along with the location of the paused content.

The data center may then initialize one or more servers to service the paused content in response to the agent handler's request as described at step 445. In some embodiments where the data center is the same as the one servicing the former client, the data center may simply reuse the servers previously servicing the paused content. Using the data center architecture described in FIG. 2 as an example, the data center may reuse the virtual machine server and corresponding renderer of the rendering server that was previously processing the paused content. However, where the data center is different from the one previously servicing the former client device or where the existing data center requires more servers, one or more servers may need to be initialized as described above in FIG. 3B.

Once the data center has initialized one or more servers, the data center receives new client device contact information from the control structure as described at step 447. The new client device contact information allows the data center to communicate directly with the new client device without having to go through the control structure. For example, in the data center architecture of FIG. 2, the renderer associated with the new client device may receive an address of the client device, such that the renderer may directly transmit rendered video game images to the new client device.

The one or more servers associated with the new client device may then retrieve the paused content as described in step 449. Using the data center architecture described in FIG. 2 as an example, the virtual machine game server may retrieve the game binary from content stored in the one or more databases remote to the data center. Where the one or more servers associated with the new client device were previously associated with the terminated client device, the paused content may already be loaded within the server.

The data center may then process the paused content using the one or more servers associated with the new client device as described in step 451. Using the data center architecture described in FIG. 2 as an example, the virtual machine game server may generate a sequence of game binary instructions in accordance with input received from the new client device and execute the game binary instructions to generate a set of graphics command data. The set of graphics command data may be transmitted to a corresponding renderer of the rendering server where they are used to render one or more video game images.

The paused content may then be delivered by the one or more servers to the new client device as described in step 453. Using the data center architecture described in FIG. 2 as an example, the renderer may transmit the rendered one or more video game images to the new client device.

The data center may simultaneously generate metadata associated with the new client device and provide it to the control structure as described in step 455. Such metadata may include context information associated with the paused content being delivered to the new client device.

The content delivery and management system 100 of FIG. 1 may additionally provide content context save and restore functionality. Content context save and restore allows a client device to save content and restore the content at a later time. The user of a client device may choose the point at which content is stored. Alternatively the content may be automatically stored at different predetermined checkpoints. For example, paused content may be automatically stored at the point of pause once the time threshold specified lapses.

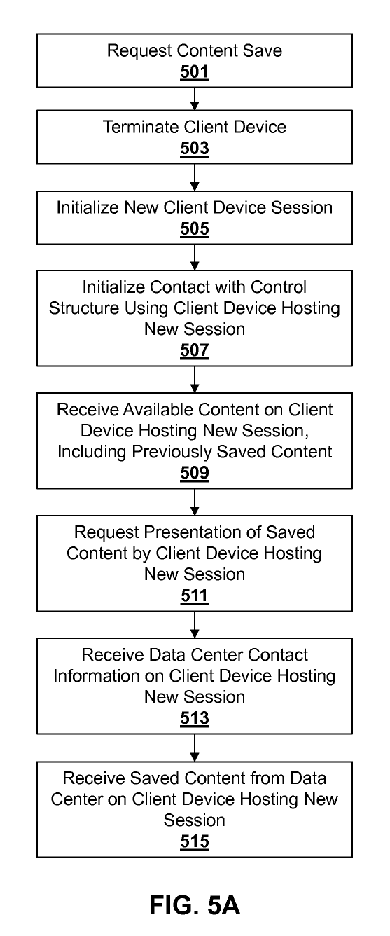

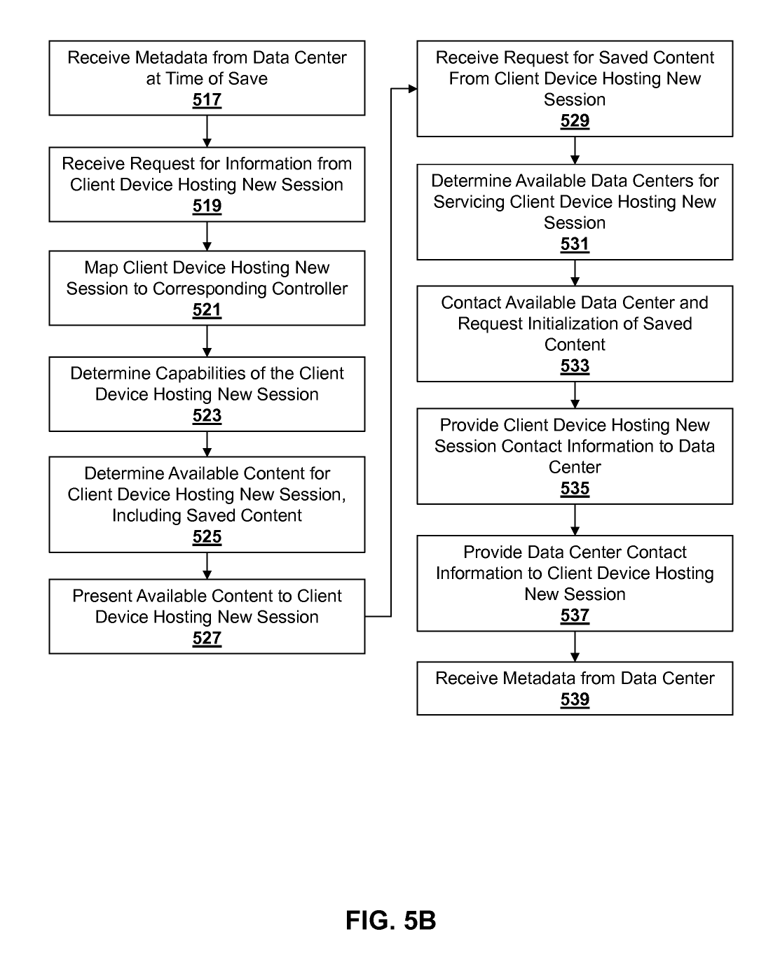

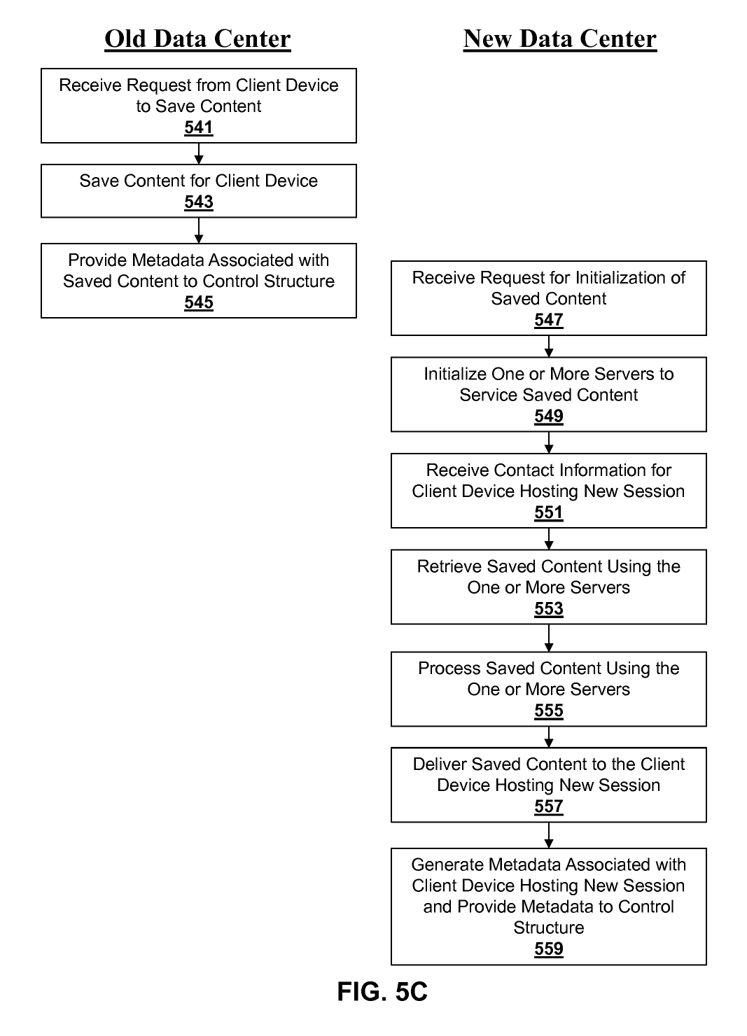

FIGS. 5A, 5B, and 5C are flow diagrams illustrating a method for implementing content context save and restore from the perspective of the user, control structure, and data center respectively for the content delivery and management system described above in FIG. 1.

FIG. 5A is a flow diagram illustrating a method for implementing content context save and restore from the perspective of the user for the content delivery and management system described above in FIG. 1.

Initially, a client device requests to save content as described in step 501. Content may be saved after an explicit request is made by the user of the client device, or content may be automatically saved when content previously paused by a client device exceeds the time threshold. The data center servicing the client may then store the saved content to an external database and provide metadata to the control structure that is subsequently used to facilitate restoring of saved content.

The client device may then terminate as described in step 503. A new client device session may then be initialized as described in step 505. As used herein, initializing the new client device session may comprise initializing a new client session using the former client device or alternatively initializing a new client session using a new client device.

The client device hosting the new session may then initialize contact with the control structure as described in step 507. The user of the client device hosting the new session may be required to provide login information to the control structure upon initialization in order for the content delivery and management system to implement the restore feature. For example, the control structure may determine what previously saved content is available for a particular user based on his login information.

After the client device hosting the new session has initialized contact with the control structure, the client device hosting the new session may receive available content from the control structure, including previously saved content as described at 509. The control structure may become aware of the availability of previously saved content using the metadata received from the data center and associated servers at the time of save.

The client device hosting the new session may then request for presentation of the saved content as described at 511. In some embodiments, requesting saved content for presentation will cause the control structure to locate a data center, initialize servers within the data center for servicing the client device hosting the new session, and load saved content from a remote database to the initialized servers. Further details will be described below.

The client device hosting the new session may then receive data center contact information as described at 513. At this point, the client device hosting the new session may communicate directly with its corresponding data center without going through the control structure. The client device hosting the new session then receives saved content from its corresponding data center as described in step 515.

FIG. 5B is a flow diagram illustrating a method for implementing content context save and restore from the perspective of the control structure for the content delivery and management system described above in FIG. 1.

When a former client device requests to save its content, the control structure receives metadata from its corresponding data center as described at 517. The metadata identifies the user of the former client device and provides information about the saved content context (e.g., time of save, location of saved content, etc.). The control structure may store the metadata received from the data center until the user decides to terminate the saved content.

The control structure then receives a request for information from the client device hosting the new session as described at step 519. The control structure may receive login information from the user of the client device hosting the new session along with the request for information.

The mapping module of the control structure will then map the client device hosting the new session to a corresponding controller as described at step 521. As described above, the mapping module may apply a set of metadata rules to the address associated with the client device hosting the new session to determine a corresponding controller. For example, the rules may direct the mapping module to assign the client device hosting the new session to a controller with associated data centers in close proximity to both the client device and the saved content.

The controller will then determine the capabilities of the client device hosting the new session based on information associated with the client device hosting the new session contained in the request for information as described in step 523. Such capabilities may include the client device type, the client device operating system, bandwidth allocated for the client device, or I/O components associated with the client device. The capabilities of the client hosting the new session will be used by the control structure to direct a data center to process saved content and deliver saved content in a manner consistent with the capabilities of the client device hosting the new session, which will be described in more detail below.

The controller may then determine available content (including saved content) for the client hosting the new session device as described in step 525. Determination of available content may be based on capabilities of the client device hosting the new session and metadata. The saved content may be determined by the controller by using user information metadata provided to the control structure at the time of save. For example, the user information metadata may identify that the particular user associated with the client device hosting the new session has previously saved content that is available for presentation.

The available content, including saved content may then be presented to the client device hosting the new session by the control structure as described in step 527. A request for saved content may then be received by the control structure from the client device hosting the new session as described at step 529. The one or more agent handlers associated with the controller may determine an available data center for servicing the client device hosting the new session as described at step 531. Servicing the client hosting the new session may involve restoration, processing and delivery of requested saved content to the client device hosting the new session. Determination of an available data center may be based on based on the capabilities of the client device hosting the new session and metadata. For example, metadata may identify the data center corresponding to the client device hosting the old session and its associated servers for processing and delivery of the saved content. Alternatively, the metadata may identify a different data center and associated servers that are more suitable for processing and delivery of saved content in accordance with the capabilities of the client device hosting the new session. For example, a client device hosting the new session may support a more limited resolution in comparison to the former client device and as such a data center with a lesser amount of GPU resources may be chosen to service the client device hosting the new session.

After determining available data centers for servicing the client device hosting the new session, the agent handler may contact the available data center and request initialization of saved content as described at step 533. Contacting the data available data center and requesting initialization of content may involve the control structure requesting the data center to initialize one or more servers to service the client device hosting the new session and providing the servers with information regarding the location of the saved content.

The control structure may then provide contact information for the hosting the new session to the data center as described at step 535. Such contact information may be an IP address associated with the client device hosting the new session that allows the data center to communicate directly with the client device hosting the new session. The control structure may simultaneously provide data center contact information to the client device hosting the new session as described at step 537. At this point, the client device hosting the new session communicates directly with its corresponding data center without having to go through the control structure, but the control structure continues to receive metadata from the data center associated with the client as described in step 539.

FIG. 5C is a flow diagram illustrating a method for implementing content context save and restore from the perspective of the data center for the content delivery and management system described above in FIG. 1.

The data center may receive a request from the client device to save content as described at 541. In some embodiments, the data center may automatically save paused content upon expiration of the time threshold allocated for paused content without receiving a request from the former client device.

The data center may then save content for the client device as described at 545. In some embodiments, saving content may comprise saving the actual content to an external database. In other embodiments, saving content may comprise saving an indication of the context associated with the content.

The data center may then provide metadata associated with the saved content to the control structure as described at 543. Such metadata may identify the user of the client device and provide information about the saved content context (e.g., time of save, location of saved content, etc.). The control structure may store the metadata received from the data center until the user decides to terminate the saved content.

A new data center then receives a request to initialize saved content from an agent handler located within the control structure as described at 547. As used herein, the term new data center refers to the data center servicing the client device hosting the new session. The new data center may be the same data center corresponding to the client device hosting the old session or may be a new data center. The request may include information regarding the resources needed to provide restoration of the saved content along with the location of the saved content.

The new data center may then initialize one or more servers to service the saved content in response to the agent handler's request as described at step 549. Using the data center architecture described in FIG. 2 as an example, the data center may initialize a virtual machine server and a corresponding renderer of the rendering server for processing the content.

Once the new data center has initialized one or more servers, the new data center receives contact information for the client device hosting the new session from the control structure as described at step 551. The contact information for the client device hosting the new session allows the new data center to communicate directly with the client device hosting the new session without having to go through the control structure. For example, in the data center architecture of FIG. 2, the renderer associated with the client device hosting the new session may receive an address of the client device, such that the renderer may directly transmit rendered video game images to the client device hosting the new session.

The one or more servers associated with the client device hosting the new session may then retrieve the saved content as described in step 553. The one or more servers associated with the client device hosting the new session may either retrieve the actual saved content (stored in an external database), or may retrieve the original content and modify it to reflect its saved context using information provided by the control structure. Using the data center architecture described in FIG. 2 as an example, the virtual machine game server may retrieve the game binary in its original context and update game settings (e.g., new levels, new characters) to reflect the saved context.

The new data center may then process the saved content using the one or more servers associated with the client device hosting the new session as described in step 555. Using the data center architecture described in FIG. 2 as an example, the virtual machine game server may generate a sequence of game binary instructions in accordance with input received from the client device hosting the new session and execute the game binary instructions to generate a set of graphics command data. The set of graphics command data may be transmitted to a corresponding renderer of the rendering server where they are used to render one or more video game images.

The saved content may then be delivered by the one or more servers to the client hosting the new session device as described in step 557. Using the data center architecture described in FIG. 2 as an example, the renderer may transmit the rendered one or more video game images to the client device hosting the new session.

The new data center may simultaneously generate metadata associated with the client device hosting the new session and provide it to the control structure as described in step 559. Such metadata may include context information associated with the paused content being delivered to the new client device.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

What is claimed is:

1. A control structure for providing content delivery and management to a client device, comprising:
a mapping module;
a plurality of controllers, wherein each controller is associated with one or more data centers configured to provide content to the client device;
a plurality of agent handlers, each agent handler associated with a controller of the plurality of controllers;
metadata;
wherein:
a) the control structure receives a request for information from the client device;
b) the mapping module maps the client device to a corresponding controller of the plurality of controllers;
c) the corresponding controller determines one or more capabilities of the client device;
d) the corresponding controller determines available content for the client device based on the client device capabilities or metadata;
e) the corresponding controller presents available content to the client device;
f) the corresponding controller receives a request for content from the client device;
g) an agent handler associated with the corresponding controller determines data centers available to service the client device;
h) the agent handler associated with the corresponding controller contacts a data center of the available data centers and requests initialization of content requested by the client;
i) the control structure provides client device contact information to the data center;
j) the control structure provides data center contact information to the client device; and
k) the control structure receives metadata associated with the client device from the data center.

2. The control structure of claim 1, further comprising a request handler configured to translate information received from the client device into an appropriate form for processing by the corresponding controller.

3. The control structure of claim 1, wherein the request for information includes an address associated with the client device.

4. The control structure of claim 1, wherein the request for information includes login information for a user of the client device.

5. The control structure of claim 1, wherein the request for information indicates a client device type, an operating system running on the client device, bandwidth allocation for the client device, I/O components associated with the client device, and a service provider associated with the client device.

6. The control structure of claim 1, wherein mapping the client device to a corresponding controller of the plurality of controllers comprises applying a set of metadata rules to an address associated with the client device.

7. The control structure of claim 1, wherein mapping the client device to a corresponding controller comprises bypassing a controller corresponding to data centers associated with a service provider of the client device for a controller corresponding to data centers associated with an associate service provider.

8. The control structure of claim 1, wherein determining data centers available to service the client device comprises obtaining information regarding data center workload and available resources by the agent handler.

9. The control structure of claim 1, wherein contacting the data center of the available data centers and requesting initialization of content requested by the client comprises providing content location information to the data center.

10. The control structure of claim 1, wherein contacting the data center of the available data centers and requesting initialization of content requested by the client comprises requesting the data center to initialize a renderer of a rendering server and a virtual machine game server to service the client device.

11. The control structure of claim 10, wherein contacting the data center of the available data centers and requesting initialization of content requested by the client further comprises providing virtual machine contact information to the renderer and renderer contact information to the virtual machine game server.

12. The control structure of claim 10, wherein providing client device contact information to the data center comprises providing an address associated with the client device to the renderer.

13. The control structure of claim 10, wherein providing data center contact information to the client device comprises providing an address associated with the virtual machine gamer server to the client device.

14. The control structure of claim 10, wherein the renderer is configured to perform GPU processing and the virtual machine game server is configured to perform CPU processing for video game content requested by the client device.

15. The control structure of claim 1, wherein determining available content for the client device comprises determining previously paused content associated with a user of the client device.

16. The control structure of claim 15, wherein receiving the request for content from the client device comprises receiving a request for the content previously paused by the user of the client device.

17. The control structure of claim 16, wherein the previously paused content was previously paused by the user while using a different client device.

18. The control structure of claim 16, wherein determining data centers available to service the client device comprises determining a data center previously servicing the paused content.

19. The control structure of claim 1, wherein determining available content for the client device comprises determining previously saved content associated with a user of the client device.

20. The control structure of claim 19, wherein receiving the request for content from the client device comprises receiving a request for the content previously saved by the user of the client device.

21. The control structure of claim 1, wherein the metadata comprises content metadata, rules metadata, or client information metadata

22. A method for providing content delivery and management to a client device, comprising:
receiving a request for information for the client device;
mapping the client device to a corresponding controller;
determining one or more capabilities of the client device;
presenting available content to the client device based on the client device capabilities or metadata;
receiving a request for content from the client device;
determining data centers available to service the client device;
contacting a data center of the available data centers and requesting initialization of content requested by the client;
providing client device contact information to the data center;
providing data center contact information to the client device; and
receiving metadata associated with the client device from the data center.

23. The method of claim 22, wherein mapping the client device to a corresponding controller comprises applying a set of metadata rules to an address associated with the client device.

24. The method of claim 22, wherein mapping the client device to a corresponding controller comprises bypassing a controller corresponding to data centers associated with a service provider of the client device for a controller corresponding to data centers associated with an associate service provider.

25. The method of claim 22, wherein determining data centers available to service the client device comprises obtaining information regarding data center workload and available resources by the agent handler.

26. The method of claim 22, wherein contacting the data center of the available data centers and requesting initialization of content requested by the client comprises providing content location information to the data center.

27. The method of claim 22, wherein contacting the data center of the available data centers and requesting initialization of content requested by the client device comprises requesting the data center to initialize a renderer of a rendering server and a virtual machine game server to service the client device.

28. The method of claim 27, wherein contacting the data center of the available data centers and requesting initialization of content requested by the client further comprises providing virtual machine contact information to the renderer and renderer contact information to the virtual machine game server.

29. The method of claim 27, wherein providing client device contact information to the data center comprises providing an address associated with the client device to the renderer.

30. The method of claim 27, wherein providing data center contact information to the client device comprises providing an address associated with the virtual machine gamer server to the client device.

31. The method of claim 27, wherein the renderer is configured to perform GPU processing and the virtual machine game server is configured to perform CPU processing for video game content requested by the client device.

32. The method of claim 22, wherein determining available content for the client device comprises determining previously paused content associated with a user of the client device.

33. The method of claim 32, wherein receiving the request for content from the client device comprises receiving a request for the content previously paused by the user of the client device.

34. The method of claim 33, wherein the previously paused content was previously paused by the user while using a different client device.

35. The method of claim 33, wherein determining data centers available to service the client device comprises determining a data center previously servicing the paused content.

36. The method of claim 22, wherein determining available content for the client device comprises determining previously saved content associated with a user of the client device.

37. The method of claim 36, wherein receiving the request for content from the client device comprises receiving a request for the content previously saved by the user of the client device.

38. The method of claim 22, wherein the metadata comprises content metadata, rules metadata, or client information metadata.

39. A method for providing content delivery and management to a client device, comprising:
mapping the client device to a corresponding controller;
presenting available content to the client device;
determining data centers available to service the client device; and
initializing a data center to service content requested by the client;

40. A method for providing content delivery and management to a user of a client device, comprising:
managing for the user of the client device content previously paused by the user while using a different client device.
